(19) United States
(12) Patent Application Publication
(10) Pub. No.: US 2026/0138500 A1
(43) Pub. Date: May 21, 2026

(54) PART-INTEGRATED MODULE OF A THERMAL MANAGEMENT SYSTEM FOR AN ELECTRIC VEHICLE

(71) Applicants: HYUNDAI MOTOR COMPANY, Seoul (KR); KIA CORPORATION, Seoul (KR)

(72) Inventors: Seong-Bin Jeong, Hwaseong-si (KR); Dongseok Oh, Hwaseong-si (KR); Ji Wan Son, Hwaseong-si (KR); Chan Woong Jo, Hwaseong-si (KR); Yong Woong Cha, Hwaseong-si (KR); Jungha Park, Hwaseong-si (KR)

(73) Assignees: HYUNDAI MOTOR COMPANY, Seoul (KR); KIA CORPORATION, Seoul (KR)

(21) Appl. No.: 19/259,155

(22) Filed: Jul. 3, 2025

(30) Foreign Application Priority Data
Nov. 20, 2024 (KR) 10-2024-0166039

(51) Int. Cl. B60L 58/27; B60L 1/00; H01M 10/613; H01M 10/615; H01M 10/625; H01M 10/6564

(52) U.S. Cl. CPC B60L 58/27; B60L 1/003; H01M 10/613; H01M 10/615; H01M 10/625; H01M 10/6564; B60L 2210/10; B60L 2210/42; H01M 2220/20

(57) ABSTRACT

A part-integrated module of a thermal management system for an electric vehicle, which is disposed in a power electric (PE) compartment of an electric vehicle, may include an electric compressor including a compressor unit configured to compress a refrigerant and including a motor unit configured to transfer a driving torque to the compressor unit. The part-integrated module further includes a temperature-boosting heater configured to heat a battery coolant. The part-integrated module further includes an integrated inverter unit coupled between the electric compressor and the temperature-boosting heater and configured to convert a DC power supplied through a high-voltage battery to an AC power and output the converted DC power to the motor unit and the temperature-boosting heater.

### CROSS-REFERENCE TO RELATED APPLICATION

This application claims the priority to and the benefit of Korean Patent Application No. 10-2024-0166039 filed on Nov. 20, 2024, the entire contents of which are incorporated herein by reference.

### TECHNICAL FIELD

The present disclosure relates to a thermal management system for an electric vehicle. More particularly, the present disclosure relates to a part-integrated module of a thermal management system for an electric vehicle, in which high-voltage components for adjusting the temperature of a vehicle interior and a high-voltage battery of an electric vehicle are integrated.

### BACKGROUND

Recently, in accordance with a continuous increase in interest in energy efficiency and an environmental pollution problem, the development of an environment-friendly vehicle capable of substantially substituting for an internal combustion engine vehicle is required.

Examples of such environment-friendly vehicles include electric vehicles (or hydrogen electric vehicles) that are powered by fuel cells or electricity, or electric vehicle-based purpose built vehicles (PBVs).

Such an electric vehicle is equipped with a thermal management system to regulate the temperature of the vehicle interior and cool heat-generating components such as a high-voltage battery. The thermal management system may be configured in a power electric (PE) compartment of the electric vehicle.

A thermal management system for an electric vehicle may adjust the temperature of the vehicle interior through an air conditioning mode, such as cooling, heating and dehumidification, or the like. The thermal management system may adjust the temperature of the battery through a battery heat management mode, such as battery cooling and heating.

Such a thermal management system for an electric vehicle is provided with a plurality of high-voltage components for adjusting the temperature of the vehicle interior and the temperature of the battery. The high-voltage components may include, an air positive temperature coefficient (PTC), an electric compressor, a temperature-boosting heater, or the like.

The electric vehicle may be provided with power control components required for controlling the drive motor and the high-voltage battery, such as a low voltage DC-DC converter (LDC), an on-board charger (OBC), a power relay assembly (PRA), a battery management unit (BMU), and a high-voltage junction box (HV JB).

These power control components may be installed, for example, on a housing of an integrated control module mounted on a pack case of the high-voltage battery.

Therefore, because high-voltage components, such as an air PTC, an electric compressor, and a temperature-boosting heater, are disposed in the PE compartment of the electric vehicle, even if an integrated control module is applied to the high-voltage battery, a separate junction box and PRA, as well as multiple high-voltage cables, are required.

The above information disclosed in this Background section is only to enhance understanding of the background of the disclosure. Therefore, the Background section may contain information that does not form the prior art that is already known to a person of ordinary skill in the art.

### SUMMARY

The present disclosure aims to provide a part-integrated module of a thermal management system for an electric vehicle, capable of simplifying the layout of the thermal management system and reducing the number of power control components and high-voltage cables in the power supply system.

A part-integrated module of a thermal management system for an electric vehicle, which is disposed in a power electric (PE) compartment of an electric vehicle, may include an electric compressor including a compressor unit configured to compress a refrigerant and including a motor unit configured to transfer a driving torque to the compressor unit. The part-integrated module may further include a temperature-boosting heater configured to heat a battery coolant. The part-integrated module may further include an integrated inverter unit coupled between the electric compressor and the temperature-boosting heater and configured to convert a DC power supplied through a high-voltage battery to an AC power and output the converted DC power to the motor unit and the temperature-boosting heater.

The motor unit may include a first power connection portion configured to be connected to the integrated inverter unit.

The temperature-boosting heater may include a second power connection portion configured to be connected to the integrated inverter unit.

The integrated inverter unit may include a first inverter case engaged with the motor unit of the electric compressor. The integrated inverter unit may further include a second inverter case engaged with the temperature-boosting heater and coupled to the first inverter case. The integrated inverter unit may further include an integrated junction unit disposed between the first inverter case and the second inverter case, fitted into a first mounting hole formed on the first inverter case, and fitted into a second mounting hole formed on the second inverter case.

The integrated junction unit may include a first voltage distribution port fitted into the first mounting hole and connected to the first power connection portion of the motor unit. The integrated junction unit may further include a second voltage distribution port fitted into the second mounting hole and connected to the second power connection portion of the temperature-boosting heater.

The integrated junction unit may further include an insulation member disposed between the first voltage distribution port and the second voltage distribution port.

The integrated inverter unit may include an integrated printed circuit board (PCB) disposed between the first inverter case and the second inverter case and configured to respectively output a predetermined voltage to the first voltage distribution port and the second voltage distribution port. The integrated PCB is connected to the integrated junction unit.

The integrated PCB may be connected to a high voltage (HV) connector and a low voltage (LV) connector mounted on the first inverter case.

The HV connector may be connected to an integrated control module mounted on the high-voltage battery through a high-voltage cable.

The integrated PCB may include a first section including an LV filter, a DC-DC converter, a communication circuit. The integrated PCB may further include a motor control unit (MCU) connected to the LV connector. The integrated PCB may further include a second section including a HV filter connected to the HV connector. The integrated PCB may further include a third section including a heater gate driver, a heater switch, and the second voltage distribution port, which are connected to the HV filter and the MCU. The integrated PCB may further include a fourth section including a motor gate driver, a motor switch, and the first voltage distribution port, which are connected to the HV filter and the MCU.

As described above, in a part-integrated module of a thermal management system for an electric vehicle according to an embodiment of the present disclosure, the layout of the thermal management system may be simplified within the limited space of the PE compartment, the number of the power control components may be reduced, and the usage of high-voltage cables may be reduced.

Other effects should be explicitly or implicitly described in a detailed description of the present disclosure. In other words, various effects that are predicted according to the present disclosure should be described in the following detailed description.

### BRIEF DESCRIPTION OF THE DRAWINGS

The drawings are intended to be used as references for describing the embodiments of the present disclosure, and the accompanying drawings should not be construed as limiting the technical spirit of the present disclosure.

FIG. 1 is a drawing schematically showing a layout of a part-integrated module of a thermal management system for an electric vehicle according to an embodiment of the present disclosure.

FIG. 2 is a perspective view showing a part-integrated module of a thermal management system for an electric vehicle according to an embodiment of the present disclosure.

FIG. 3 and FIG. 4 are exploded perspective views showing a part-integrated module of a thermal management system for an electric vehicle according to an embodiment of the present disclosure.

FIG. 5 and FIG. 6 are perspective views showing an integrated inverter unit applied to a part-integrated module of a thermal management system for an electric vehicle according to an embodiment of the present disclosure.

FIG. 7 and FIG. 8 are exploded perspective views showing an integrated inverter unit applied to a part-integrated module of a thermal management system for an electric vehicle according to an embodiment of the present disclosure.

FIG. 9 is a block diagram schematically showing an integrated printed circuit board (PCB) of an integrated inverter unit applied to a part-integrated module of a thermal management system for an electric vehicle according to an embodiment of the present disclosure.

It should be understood that the above-referenced drawings are not necessarily to scale and present a somewhat simplified representation of various preferred features illustrating the basic principles of the disclosure. The specific design features of the present disclosure, including, for example, specific dimensions, orientations, locations, and shapes, will be determined in part by the particular intended application and use environment.

### DETAILED DESCRIPTION

The terms used herein are for the purpose of describing specific examples only and are not intended to limit the present disclosure. As used herein, the singular forms are intended to include the plural forms as well, unless the context clearly indicates otherwise.

In addition, it should be understood that terms “comprise,” and/or “include” used in the present disclosure specify the presence of features, numerals, steps, operations, elements and/or components and do not preclude the presence or addition of one or more other features, numerals, steps, operations, components and/or groups thereof.

In addition, the term “coupled” used herein indicates a physical relationship between two components directly connected to each other, or indirectly connected to each other through one or more intervening components. When a controller, apparatus, module, component, device, element, or the like of the present disclosure is described as having a purpose or performing an operation, function, or the like, the controller, apparatus, module, component, device, element, or the like should be considered herein as being “configured to” meet that purpose or to perform that operation or function. Each controller, apparatus, module, component, device, element, and the like may separately embody or be included with a processor and a memory, such as a non-transitory computer readable media, as part of the apparatus.

It should be understood that the term, such as “vehicle,” “vehicular,” “car,” or other similar term, as used herein includes passenger automobiles including sport cars, sports utility vehicles (SUV), buses, trucks, various commercial vehicles and includes hybrid vehicles, electric vehicles, hybrid electric vehicles, hydrogen-powered vehicles, purpose-built vehicles (PBV), and other alternative fuel vehicles (e.g., fuels derived from resources other than petroleum), equipped with a high voltage battery.

Hereinafter, an example of the present disclosure is described in detail with reference to the accompanying drawing.

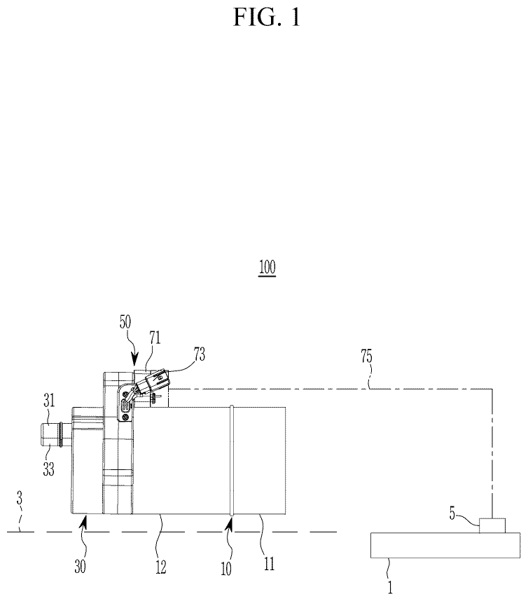

FIG. 1 is a drawing schematically showing a layout of a part-integrated module of a thermal management system for an electric vehicle according to an embodiment of the present disclosure.

Referring to FIG. 1, a part-integrated module 100 of a thermal management system for the electric vehicle according to an embodiment of the present disclosure may be applied to a thermal management system of an environment-friendly vehicle.

Here, the environment-friendly vehicle may be an electric vehicle or an electric vehicle-based purpose-built vehicle (PBV), which is driven by a power source of the electricity charged in a high-voltage battery 1.

A part-integrated module 100 of a thermal management system for the electric vehicle according to an embodiment of the present disclosure may adjust the temperature of the vehicle interior of the electric vehicle and may be applied to a thermal management system for adjusting the temperature of the high-voltage battery 1.

The thermal management system of the electric vehicle may perform a vehicle interior cooling mode, a battery cooling mode, and a vehicle interior cooling/battery cooling mode.

A part-integrated module 100 of a thermal management system for the electric vehicle according to an embodiment of the present disclosure may be disposed in a power electric (PE) compartment 3 of the electric vehicle. A PE compartment 3 may be disposed, for example, on an upstream side of the electric vehicle.

Such a part-integrated module 100 of a thermal management system for the electric vehicle according to an embodiment of the present disclosure can provide a structure capable of simplifying the layout of the thermal management system and reducing the number of power control components and high-voltage cables in the power supply system.

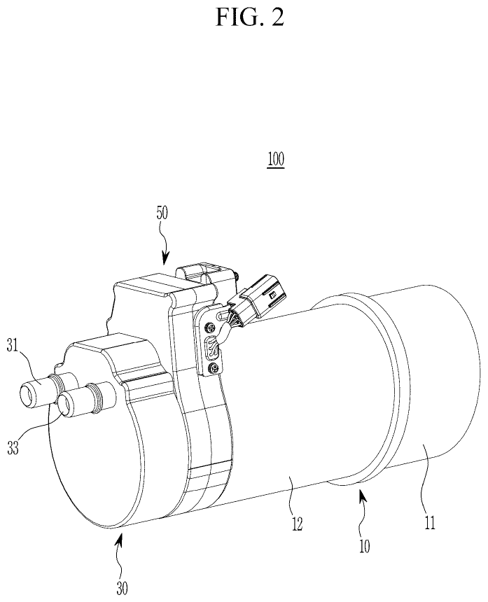

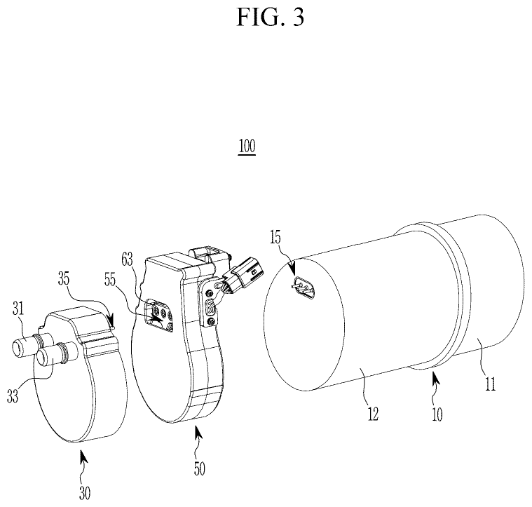

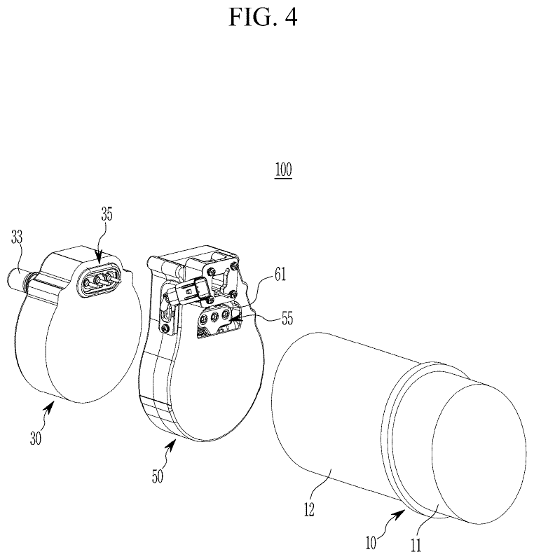

FIG. 2 is a perspective view showing a part-integrated module of a thermal management system for an electric vehicle according to an embodiment of the present disclosure, and FIG. 3 and FIG. 4 are exploded perspective views showing a part-integrated module of a thermal management system for an electric vehicle according to an embodiment of the present disclosure.

Referring to FIG. 1-FIG. 4, a part-integrated module 100 of a thermal management system for the electric vehicle according to an embodiment of the present disclosure may include an electric compressor 10, a temperature-boosting heater 30, and an integrated inverter unit 50.

In an embodiment, the electric compressor 10 is configured to compress a refrigerant used for cooling and heating of the vehicle interior of the electric vehicle.

The electric compressor 10 may include a compressor unit 11 configured to compress the refrigerant and may include a motor unit 12 configured to transfer a driving torque for compressing the refrigerant to the compressor unit 11. The compressor unit 11 and the motor unit 12 may be coupled to each other, and a refrigerant suction portion and a refrigerant discharge portion may be formed in the compressor unit 11.

Here, the motor unit 12 may be operated by a power supplied from the high-voltage battery 1 and may be coupled to the integrated inverter unit 50 to be described below. The motor unit 12 may include a first power connection portion 15 that can be connected to the integrated inverter unit 50 electrically and signal-wise.

In an embodiment, the temperature-boosting heater 30 is configured to convert the electrical energy supplied from the high-voltage battery 1 into the thermal energy, to increase a temperature of a battery coolant.

The temperature-boosting heater 30 may be coupled to the integrated inverter unit 50 to be described below. The temperature-boosting heater 30 may include a coolant inlet 31 and a coolant outlet 33.

The temperature-boosting heater 30 may include a second power connection portion 35 that can be connected to the integrated inverter unit 50 electrically and signal-wise.

In an embodiment, the integrated inverter unit 50 is configured to convert a DC power supplied through the high-voltage battery 1 to an AC power and distribute the converted DC power to the motor unit 12 and the temperature-boosting heater 30 of the electric compressor 10.

Furthermore, the integrated inverter unit 50 may calculate a limit value of the electrical power that can be allocated to the electric compressor 10 and the temperature-boosting heater 30. The integrated inverter unit 50 may output the electrical power according to the calculated value to the electric compressor 10 and the temperature-boosting heater 30.

The integrated inverter unit 50 may be disposed between the motor unit 12 and the temperature-boosting heater 30 of the electric compressor 10 and may be coupled to the motor unit 12 and the temperature-boosting heater 30.

In other words, the electric compressor 10 and the temperature-boosting heater 30 may be integrated by the integrated inverter unit 50 interposing the integrated inverter unit 50.

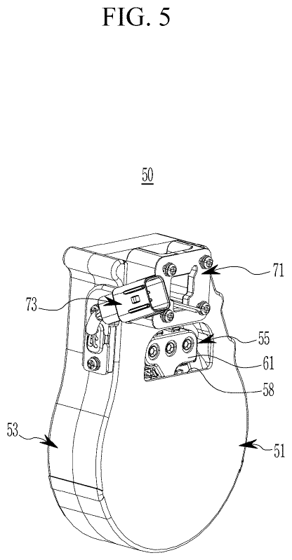

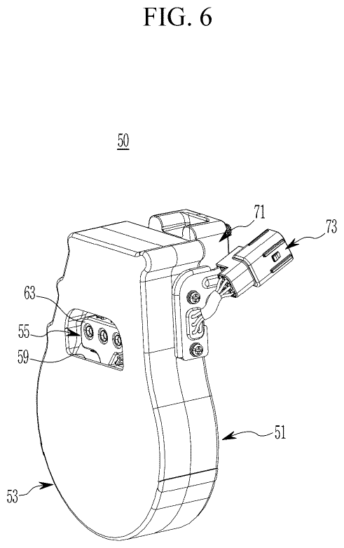

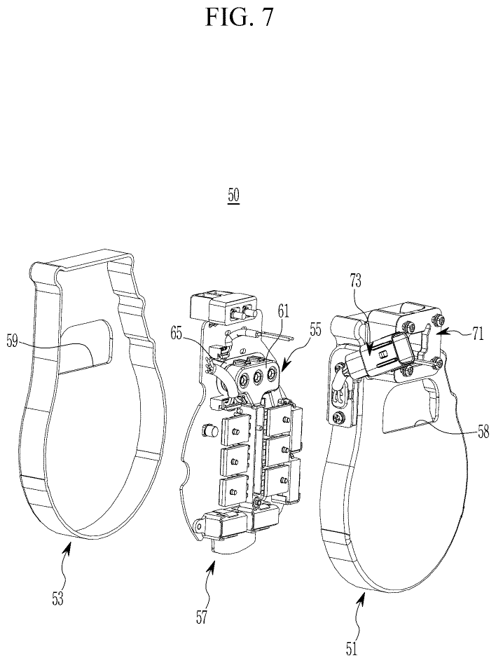

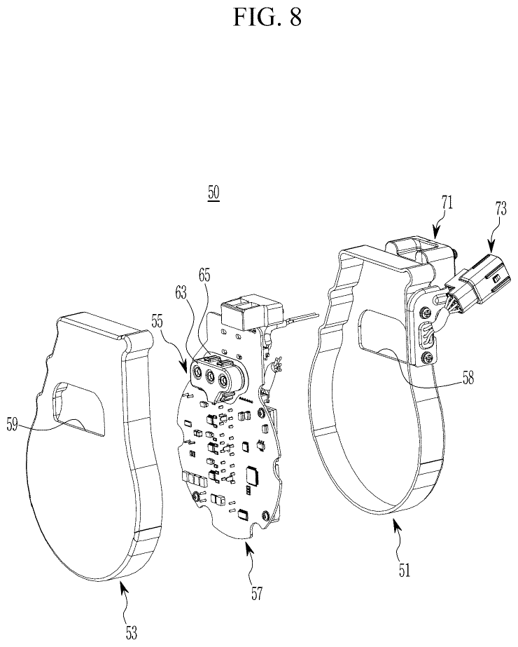

FIG. 5 and FIG. 6 are perspective views showing the integrated inverter unit applied to a part-integrated module of a thermal management system for an electric vehicle according to an embodiment of the present disclosure. FIG. 7 and FIG. 8 are exploded perspective views showing the integrated inverter unit applied to a part-integrated module of a thermal management system for an electric vehicle according to an embodiment of the present disclosure.

Referring to FIG. 3-FIG. 8, the integrated inverter unit 50 according to an embodiment of the present disclosure may include a first inverter case 51, a second inverter case 53, an integrated junction unit 55, and an integrated printed circuit board (PCB) 57.

The first inverter case 51 may be engaged with the motor unit 12 of the electric compressor 10. The second inverter case 53 may be engaged with the temperature-boosting heater 30 and may be coupled to the first inverter case 51.

The integrated junction unit 55 is configured to distribute the high-voltage electrical power supplied from the high-voltage battery 1 to the motor unit 12 and the temperature-boosting heater 30 of the electric compressor 10. The integrated junction unit 55 may include a fuse, a relay, a diode, or the like.

In an embodiment, the integrated junction unit 55 may be disposed between the first inverter case 51 and the second inverter case 53 coupled to each other. The integrated junction unit 55 may be fitted into a first mounting hole 58 formed on the first inverter case 51 and may be fitted into a second mounting hole 59 formed on the second inverter case 53.

The integrated junction unit 55 may include a first voltage distribution port 61, a second voltage distribution port 63, and an insulation member 65.

The first voltage distribution port 61 may be fitted into the first mounting hole 58 of the first inverter case 51 and may be connected to the first power connection portion 15 of the motor unit 12.

The second voltage distribution port 63 may be fitted into the second mounting hole 59 of the second inverter case 53 and may be connected to the second power connection portion 35 of the temperature-boosting heater 30.

The insulation member 65 is configured to electrically insulate the first voltage distribution port 61 and the second voltage distribution port 63. The insulation member 65 may be disposed between the first voltage distribution port 61 and the second voltage distribution port 63. Here, the first voltage distribution port 61 and the second voltage distribution port 63 may be coupled to each other by the insulation member 65.

The integrated PCB 57 may be provided as a single PCB and may be configured to respectively output predetermined voltage to the first voltage distribution port 61 and the second voltage distribution port 63 of the integrated junction unit 55.

The integrated PCB 57 may be disposed between the first inverter case 51 and the second inverter case 53 coupled to each other and may be connected to the integrated junction unit 55 electrically and signal-wise.

Furthermore, the integrated PCB 57 may be connected to a high voltage (HV) connector 71 and a low voltage (LV) connector 73 mounted on the first inverter case 51.

The HV connector 71 is configured to supply the high-voltage electrical power from the high-voltage battery 1 (hereinafter, see FIG. 1) to the integrated junction unit 55 and the high voltage elements of the integrated PCB 57. In addition, the LV connector 73 is configured to supply a low-voltage electrical power from the high-voltage battery 1 to low voltage elements of the integrated PCB 57. Here, the low voltage may be defined as a voltage of several volts or tens of volts, and high voltage may be defined as a voltage of several hundred volts.

Here, as shown in FIG. 1, the HV connector 71 may be connected to an integrated control module 5 mounted on the high-voltage battery 1 through a high-voltage cable 75. In an example, as described in the related art, the integrated control module 5 may include a low voltage DC-DC converter (LDC), an on-board charger (OBC), a power relay assembly (PRA), a battery management unit (BMU), and a high-voltage junction box (HV JB), or the like, installed in the interior of the housing.

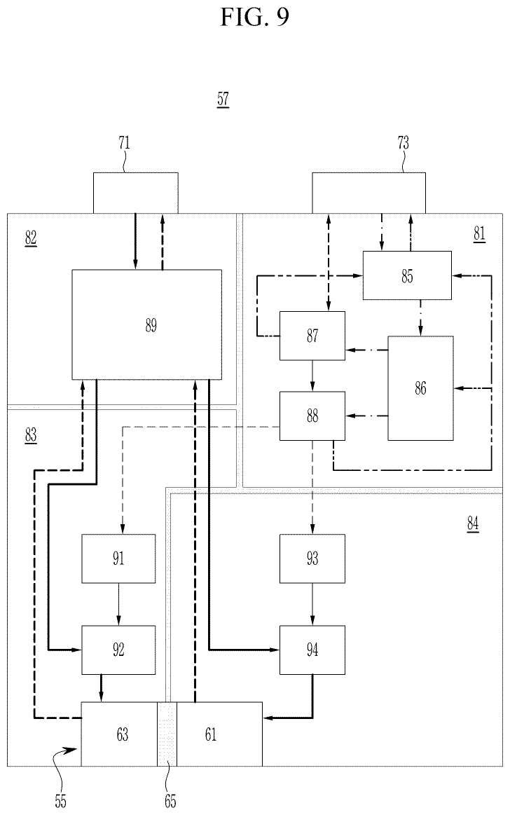

In more detail, as shown in FIG. 9, the integrated PCB 57 as described above may include a first section 81, a second section 82, a third section 83, and a fourth section 84.

The first section 81 may include an LV filter 85, a DC-DC converter 86, a communication circuit 87, and a motor control unit (MCU) 88, which are connected to the LV connector 73. The second section 82 may include a HV filter 89 connected to the HV connector 71.

The third section 83 may include a heater gate driver 91, a heater switch 92, and the second voltage distribution port 63 of the integrated junction unit 55, which are connected to the HV filter 89 and the MCU 88.

In addition, the fourth section 84 may include a motor gate driver 93, a motor switch 94, and the first voltage distribution port 61 of the integrated junction unit 55, which are connected to the HV filter 89 and the MCU 88.

Here, the communication circuit 87, the MCU 88, the heater gate driver 91, and the motor gate driver 93 may be connected to each other signal-wise.

As described above, the configuration and operation of elements provided in the first section 81, the second section 82, the third section 83, and the fourth section 84 may be known to a person having ordinary skill in the art, and a detailed description thereof has been omitted herein.

Therefore, in a part-integrated module 100 of a thermal management system for the electric vehicle according to an embodiment of the present disclosure configured as described above, the electric compressor 10 and the temperature-boosting heater 30 distributed in the PE compartment 3 of the electric vehicle may be integrated by the integrated inverter unit 50.

Accordingly, in a part-integrated module 100 of a thermal management system for the electric vehicle according to an embodiment of the present disclosure, the layout of the thermal management system may be simplified within the limited space of the PE compartment 3.

Furthermore, in a part-integrated module 100 of a thermal management system for the electric vehicle according to an embodiment of the present disclosure, the electrical power required for the operation of the electric compressor 10 and the temperature-boosting heater 30 may be output through the single integrated inverter unit 50.

In other words, the integrated inverter unit 50 may distribute voltages to the first voltage distribution port 61 and the second voltage distribution port 63 of the integrated junction unit 55 by the integrated PCB 57 configured as a single PCB and may output a predetermined voltage to the electric compressor 10 and the temperature-boosting heater 30 through the first voltage distribution port 61 and the second voltage distribution port 63.

Therefore, in a part-integrated module 100 of a thermal management system for the electric vehicle according to an embodiment of the present disclosure, the number of parts in power control components such as a junction box and a PRA can be reduced, and the usage of high-voltage cables can be reduced.

While the present disclosure has been described in the embodiments, it should be understood that the present disclosure is not limited to the disclosed embodiments. On the contrary, it is intended to cover various modifications and equivalent arrangements included within the spirit and scope of appended claims.

### DESCRIPTION OF SYMBOLS

1: high-voltage battery 3: PE compartment
5: integrated control module 10: electric compressor
11: compressor unit 12: motor unit
15: first power connection portion
30: temperature-boosting heater
31: coolant inlet 33: coolant outlet
35: second power connection portion
50: integrated inverter unit
51: first inverter case 53: second inverter case
55: integrated junction unit 57: integrated PCB
58: first mounting hole 59: second mounting hole
61: first voltage distribution port
63: second voltage distribution port
65: insulation member 71: HV connector
73: LV connector 75: high-voltage cable
81: first section 82: second section
83: third section 84: fourth section
85: LV filter 86: DC-DC converter
87: communication circuit 88: MCU
89: HV filter 91: heater gate driver
92: heater switch 93: motor gate driver
94: motor switch
100: part-integrated module of thermal management system for the electric vehicle

What is claimed is:

1. A part-integrated module of a thermal management system for an electric vehicle, the part-integrated module being disposed in a power electric (PE) compartment of an electric vehicle, the part-integrated module comprising:
an electric compressor comprising:
a compressor unit configured to compress a refrigerant; and
a motor unit configured to transfer a driving torque to the compressor unit;
a temperature-boosting heater configured to heat a battery coolant; and
an integrated inverter unit coupled between the electric compressor and the temperature-boosting heater and configured to convert a DC power supplied through a high-voltage battery to an AC power and output the converted DC power to the motor unit and the temperature-boosting heater.

2. The part-integrated module of claim 1, wherein:
the motor unit comprises a first power connection portion configured to be connected to the integrated inverter unit; and
the temperature-boosting heater comprises a second power connection portion configured to be connected to the integrated inverter unit.

3. The part-integrated module of claim 2, wherein the integrated inverter unit comprises:
a first inverter case engaged with the motor unit of the electric compressor;
a second inverter case engaged with the temperature-boosting heater and coupled to the first inverter case; and
an integrated junction unit disposed between the first inverter case and the second inverter case, fitted into a first mounting hole formed on the first inverter case, and fitted into a second mounting hole formed on the second inverter case.

4. The part-integrated module of claim 3, wherein the integrated junction unit comprises:
a first voltage distribution port fitted into the first mounting hole and connected to the first power connection portion of the motor unit; and
a second voltage distribution port fitted into the second mounting hole and connected to the second power connection portion of the temperature-boosting heater.

5. The part-integrated module of claim 4, wherein the integrated junction unit further comprises an insulation member disposed between the first voltage distribution port and the second voltage distribution port.

6. The part-integrated module of claim 4, wherein the integrated inverter unit comprises an integrated printed circuit board (PCB) disposed between the first inverter case and the second inverter case and configured to respectively output a predetermined voltage to the first voltage distribution port and the second voltage distribution port, the integrated PCB connected to the integrated junction unit.

7. The part-integrated module of claim 6, wherein the integrated PCB is connected to a high voltage (HV) connector and a low voltage (LV) connector mounted on the first inverter case.

8. The part-integrated module of claim 7, wherein the HV connector is connected to an integrated control module mounted on the high-voltage battery through a high-voltage cable.

9. The part-integrated module of claim 7, wherein the integrated PCB comprises:
a first section comprising an LV filter, a DC-DC converter, a communication circuit, and a motor control unit (MCU) connected to the LV connector;
a second section comprising an HV filter connected to the HV connector;
a third section comprising a heater gate driver, a heater switch, and the second voltage distribution port, which are connected to the HV filter and the MCU; and
a fourth section comprising a motor gate driver, a motor switch, and the first voltage distribution port, which are connected to the HV filter and the MCU.
